(19) United States
(12) Patent Application Publication
(10) Pub. No.: US 2016/0265446 A1
(43) Pub. Date: Sep. 15, 2016

(54) BRACKET ASSEMBLY FOR AN INTAKE MANIFOLD, THE INTAKE MANIFOLD AND METHOD OF OPERATING THE SAME

(71) Applicant: FORD GLOBAL TECHNOLOGIES, LLC, Dearborn, MI (US)

(72) Inventors: CHRISTOPHER WILLIAM NEWMAN, FARMINGTON HILLS, MI (US); MIKE HAMZEH, FLAT ROCK, MI (US); KATHERINE JANE RANDALL, BELLEVILLE, MI (US)

(21) Appl. No.: 14/656,788

(22) Filed: Mar. 13, 2015

(51) Int. Cl. F02D 9/02; F02M 35/104

(52) U.S. Cl. CPC F02D 9/02; F02M 35/104; F02D 2009/0206

(57) ABSTRACT

In one or more embodiments, a bracket assembly for an intake manifold having a shaft is provided to include a bracket to be positioned at least partially external to the intake manifold and defining a shaft aperture to partially receive the shaft, and an elastic retainer to be positioned at least partially between the shaft and a wall of the shaft aperture. The elastic retainer may be positioned to contact the shaft or may be positioned to contact an external surface of the intake manifold.

### TECHNICAL FIELD

The present invention in one or more embodiments relates to a bracket assembly for an intake manifold, the intake manifold and a method of operating the same.

### BACKGROUND

Vehicle internal combustion engines are often provided with an intake manifold to control air flow to the engine. In certain vehicle designs, the intake manifold may be equipped with a rotatable control valve to control the air flow into the intake manifold.

The U.S. Patent Application Publication US2010/0294227 discloses an intake manifold system of an internal combustion engine, including the use of a controller to control the rotatable movement of its shaft.

### SUMMARY

In one aspect, a bracket assembly for an intake manifold having a shaft is provided to include a bracket to be positioned at least partially external to the intake manifold and defining a shaft aperture to partially receive the shaft, and an elastic retainer to be positioned at least partially between the shaft and a wall of the shaft aperture. The elastic retainer may be positioned to contact the shaft or may be positioned to contact an external surface of the intake manifold.

The bracket assembly may further include an actuating arm positioned to contact the shaft, wherein the actuating arm may contact the elastic retainer. The actuating arm may include a main arm and an arm pin, the arm pin being positioned to contact the shaft, the main arm extending from the arm pin at an angle.

The bracket may define first and second fastener apertures to receive first and second fasteners, respectively, the elastic retainer being positioned between the first and second fastener apertures. The elastic retainer may be positioned to be partially between the bracket and an external surface of the intake manifold.

In another aspect, an intake manifold is provided to include the bracket assembly with one or more features described herein.

In yet another aspect, a method if provided to operate the intake manifold with one or more features described herein.

One or more advantageous features as described herein will be readily apparent from the following detailed description of one or more embodiments when taken in connection with the accompanying drawings.

### BRIEF DESCRIPTION OF THE DRAWINGS

For a more complete understanding of one or more embodiments of the present invention, reference is now made to the one or more embodiments illustrated in greater detail in the accompanying drawings and described below wherein:

FIG. 1A illustratively depicts a perspective view of an intake manifold according to one or more embodiments;

FIG. 1B illustratively depicts an enlarged, partial view of the intake manifold referenced in FIG. 1A;

FIG. 10 illustratively depicts an enlarged, partial cross-sectional view of the intake manifold referenced in FIG. 1A, taken along line 10-10;

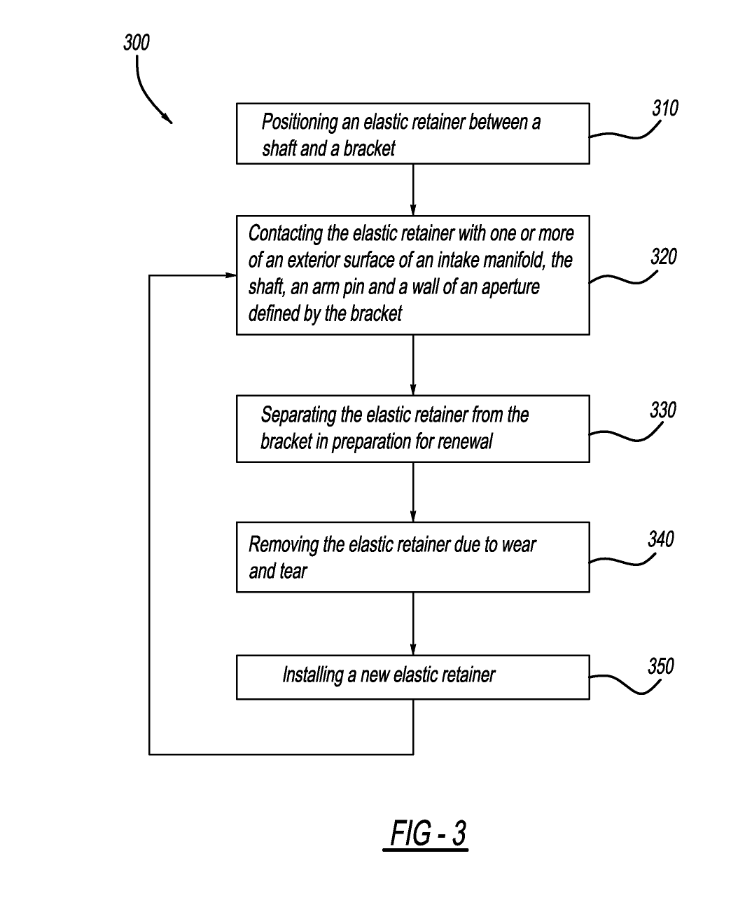

FIG. 2 illustratively depicts an alternative view of the cross-section referenced in FIG. 10; and

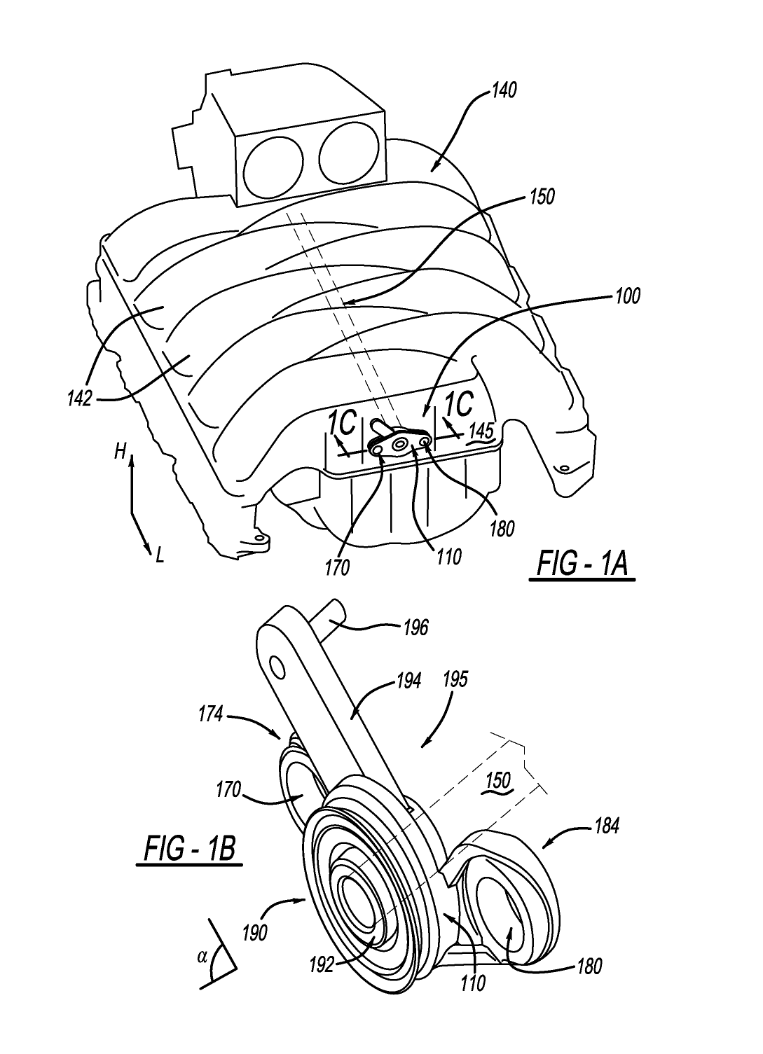

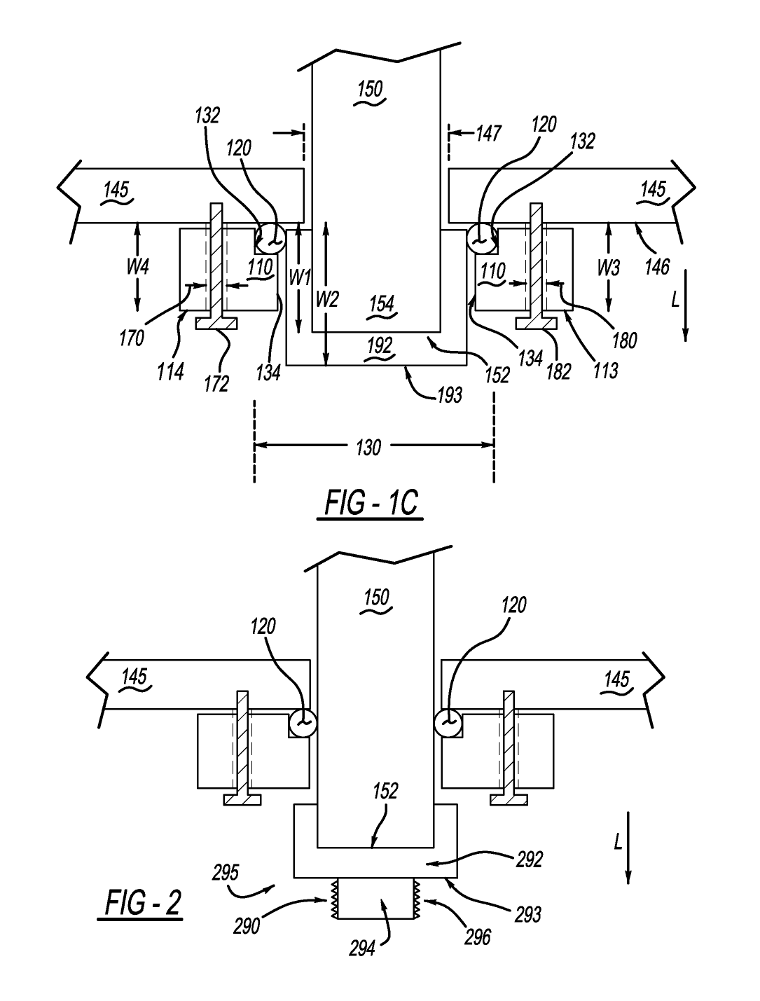

FIG. 3 illustratively depicts a non-limiting process flow of operating the intake manifold referenced in FIG. 1A through FIG. 2.

### DETAILED DESCRIPTION OF ONE OR MORE EMBODIMENTS

As referenced in the FIGS., the same reference numerals are used to refer to the same components. In the following description, various operating parameters and components are described for different constructed embodiments. These specific parameters and components are included as examples and are not meant to be limiting. The drawings referenced herein are schematic and associated views thereof are not necessarily drawn to scale.

As may be discussed herein elsewhere, the present invention in one or more embodiments is believed to be advantageous in providing a bracket assembly or an intake manifold incorporating the same, where relatively enhanced connection stability may be realized via the employment of an elastic retainer, such that noise-vibration-harshness performance may be enhanced and assembly complexity or cost may be reduced.

FIGS. 1A through 10 illustratively depict several views of a bracket assembly 100 and an intake manifold 140 employing the same. The bracket assembly 100 includes a bracket 110 to be positioned at least partially external to the intake manifold 140 and defining a bracket shaft aperture 130 to partially receive a shaft 150, and an elastic retainer 120 to be positioned at least partially between the shaft 150 and a wall 132 of the bracket 110 that defines the bracket shaft aperture 130.

The intake manifold 140 may be of any suitable forms and shapes. In certain embodiments, and as illustratively depicted in FIG. 1A, the intake manifold 140 may include a number of long/short runner control runners 142 which, along with the shaft 150, are positioned to control air flow into and out from the intake manifold 140.

Referring back to FIG. 1A through FIG. 10, the shaft 150 extends out of an external surface 146 of a housing 145 of the intake manifold 140 such that the shaft 150 is well supported on the housing 145.

Referring back to FIG. 1B, the bracket 110 may include first and second fastener portions 174, 184, defining thereon first and second fastener apertures 170, 180, which are in turn to receive first and second fasteners 172, 182, respectively. The bracket 110 may further include a shaft portion 190 positioned between the first and second fastener portions 174, 184. In certain embodiments, the first and second fastener portions 174, 184 and the shaft portion 190 may be formed integral to one another to deliver additional labor and cost benefits. However, and in some other embodiments, any of the first and second fastener portions 174, 184 and the shaft portion 190 may be of a different material relative to one another and/or may be pre-formed and subsequently assembled. The first and second fastener portions 174, 184 and the shaft portion 190 may each independently be of any suitable material, with non-limiting examples thereof including metals, plastics, polymers and graphite.

Referring back to FIG. 10 and in view of FIG. 1B, the bracket 110 may be attached to the intake manifold 140 and its external surface 146 in particular via the first and second fasteners 172, 182 received through the first and second fastener apertures 170, 180. The first and second fasteners 172, 182 may be of any suitable material and/or any suitable shape, and may end within the housing 145 or extend beyond the housing 145 to end in an area (not shown) internal to the housing 145. In certain embodiments, two or more fastener apertures and hence two or more fasteners may be configured on either side of the shaft portion 190, although only one each, namely the first and second fasteners 172, 182 are illustratively depicted in FIG. 1A through FIG. 10.

In certain embodiments, and as illustratively depicted in FIG. 10 in view of FIG. 1B, the bracket assembly 100 may further include an actuating arm 195 to facilitate the movement of the shaft 150 and to control the extent of that movement. The actuating arm 195 may include a main arm 194 and an arm pin 192, where the arm pin 192 is to receive the shaft 150 and more particularly an end portion 154 thereof including an end surface 152 of the shaft 150. In particular, the arm pin 192 may be attached to the shaft 150 such that the shaft 150 moves with the arm pin 192, which in turn moves with the main arm 194.

Referring back to FIG. 10, each of the first and second fastener portions 174, 184 and the shaft portion 190 may independently be of any suitable depth or thickness away from the exterior surface 146 along a lateral direction “L.” For instance, the first and second fastener portions 174, 184 may be of a depth “W4”, “W3”, respectively, and the pin arm 192 may be of a depth “W2” and the shaft 150 may be of a depth “W1”, wherein the depth “W1” is a distance between the exterior surface 146 of the housing 145 and an end surface 193 of the arm pin 192, the depth “W2” is a distance between the exterior surface 146 of the housing 145 and an end surface 152 of the shaft 150, the depth “W3” is a distance between the exterior surface 146 and a first fastener portion surface 113, and the depth “W4” is a distance between the exterior surface 146 and a second fastener portion surface 114. In the depictions of FIG. 10 and FIG. 2, W2 is greater than W1, however W2 may be the same to or smaller than W1 where the end surface 152 of the shaft 150 may extend further away from the end surface 193 along the direction “L”. Moreover, W3 may be the same to or different from W4 as needed.

As may be mentioned herein elsewhere, the elastic retainer 120 is advantageously positioned to flexibly restrain undesirable movement of the shaft 150 and hence to help deliver more desirable performance in noise-vibration-harshness. In certain embodiments, and as illustratively depicted in FIG. 10, the elastic retainer 120 is positioned among the arm pin 192, the external surface 146 of the housing 145 and the wall 132. In particular, the elastic retainer 120 contacts at least one of the arm pin 192, the external surface 146 of the housing 145 and the wall 132. In this configuration, and because the housing 145 and the bracket 110 are relatively fixed to each other due to the presence of the first and second fasteners 172, 182, the elastic retainer 120 is relatively stabilized in its position. On the other hand, the elastic retainer 120 is more elastic and hence flexible in material than any one of the housing 145, the bracket 110 and the arm pin 192, the elastic retainer 120 may deform against the housing 145 or the bracket 110 to help maintain the position of the arm pin 192 and hence the shaft 150. This is particularly helpful in the working environment of the intake manifold 140 where less than desirable stability of the shaft 150 may translate to an amount of noise-vibration-harshness that may not be acceptable. As can be seen, the elastic retainer 120 may be formed of any suitable elastic material such as rubber or other polymers and may be readily employed before, during and after any parts of the bracket assembly 100 is assembled to the intake manifold 140, additional benefit in labor and cost efficiencies may be realized.

In certain embodiments, the shaft 150 or the arm pin 192 may be in a snuggly engagement with the elastic retainer 120, wherein a cross-sectional dimension such as a cross-sectional width or diameter of the shaft 150 or the arm pin 192 is greater than an open dimension such as an interior diameter of the elastic retainer 120. In this configuration, receipt of the shaft 150 or the arm pin 192 into or through the elastic retainer 120 requires externally applied force. Therefore the force exerted between the elastic retainer 120 and the shaft 150 or the arm pin 192 is relatively increased and accordingly a greater engagement may be realized.

Referring back to FIG. 10, and as mentioned herein elsewhere, the end portion 154 of the shaft 150 that includes the end surface 152 is received into the arm pin 192, and accordingly the bracket shaft aperture 130 is not a through-aperture or a through-hole. Alternatively, the bracket shaft aperture 130 is configured as a through-hole or a partial through-hole (not shown) such that at least a portion of the end surface 152 of the shaft 150 is open to an exterior environment. When configured a partially covered aperture or a covered aperture such as the view depicted in FIG. 10, an added benefit is provided such that the shaft 150 may be guarded against unwanted dirt or particle contamination and hence unwanted noise or vibration due to dirt or particle accumulation may also be reduced.

The cross-sectional width of the bracket shaft aperture 130 may vary dependent upon the particular position of the shaft 150 relative to the bracket 110. For instance, and as illustratively depicted in FIG. 10, the cross-sectional width of the bracket shaft aperture 130 may be defined by the wall 132. Alternatively, the cross-sectional width of the bracket shaft aperture 130 may be defined between another wall 134 of the bracket 110. Common to both definitions is the fact that the cross-sectional width of the bracket shaft aperture 130 should be broad enough to receive the pin arm 192 along with the end surface 152 containing portion of the shaft 150 received therein. In the configuration depicted in FIG. 10, a cross-sectional distance between the walls 132, 134 at least partially accommodates the presence of the elastic retainer 120. The cross-sectional width or dimension of the bracket shaft aperture 130 may be of any suitable shape, optionally cylindrical in particular, and may vary in size as mentioned herein to respond to design and strength variations as desirable.

The elastic retainer 120 is advantageously positioned to provide further benefits, such as its function as a seal against unwanted fluid, dirt or particle entry or release. For instance, and as illustratively depicted in FIG. 10, an interior environment of the intake manifold 140 is effectively separated from its exterior counterpart by the collective presence of the housing 145, the arm pin 192, and the elastic retainer 120. Because of this, a housing shaft aperture 147 defined by the housing 145 and through which the shaft 150 enters into the arm pin 192 may be provided with relatively more design freedom, and accordingly an intended or unintended shape irregularity on the housing shaft aperture 147 may be more tolerable. Similarly, and as illustratively depicted in FIG. 2, the separation effect is carried out via the collective presence of the housing 145, the shaft 150 and the elastic retainer 120.

In certain embodiments, the elastic retainer 120 may be positioned differently along the lateral direction “L” than the positioned depicted in FIG. 10 or FIG. 2. While the elastic retainer 120 is depicted in FIG. 10 and FIG. 2 as next to or touching the exterior surface 146 of the housing 145, the elastic retainer 120 may be positioned further away and hence spaced apart from the exterior surface 146 along the lateral direction “L” when as needed. This design may be particularly beneficial for installation, where the elastic retainer 120 may be pre-installed into a cavity or recess along a side wall of the bracket 110 and then the bracket 110 with the elastic retainer 120 retained therein may be mounted onto the exterior surface 146 with greater ease.

Referring back to FIG. 1B, the main arm 194 extends from the arm pin 192 at an angle “α” which may be of any suitable value to facilitate the rotation of the shaft 150. Non-limiting examples of a range of the angle α include 30 to 180 degrees, 45 to 165 degrees and 60 to 150 degrees. In certain embodiments, the angle α is of a value within the range of 75 to 105 degrees or 85 to 95 degrees.

FIG. 2 illustratively depicts an actuating arm 295 as a variation to the actuating arm 195 referenced in FIG. 1B and FIG. 10. The actuating arm 295 includes a main arm 294 extending from an arm pin 292, where the arm pin 292 or at least a portion thereof is positioned between the elastic retainer 120 and the main arm 294 along the lateral direction “L.” This configuration may be more beneficial in designs where space is relatively more limited in a height direction “H” than in the lateral direction “L.”

Referring back to FIG. 1B, a connector 196 may be positioned on the main arm 194 to be in operational connection with an actuator (not shown) for the rotation of the shaft 150 to occur. Similarly and as illustratively depicted in FIG. 2, a connector 296 may also be present on the main arm 294 for an operational connection with an actuator (not shown). The connector 196 and 296 may be of any suitable shape and of any suitable material. In a non-limiting example, while the connector 196 may be an elongated handle, the connector 296 may be a plurality of teeth or protrusions.

The main arm 194, 294 and the arm pin 192, 292 may each independently be of any suitable material and be of any suitable dimension, with non-limiting examples of a cross-section thereof including a circle, an oval, a square, a triangle, a rectangular and any other suitable symmetrical or asymmetrical shapes.

Moreover, the main arm 194, 294 may be connected to the arm pin 192, 292 with any suitable method such as adhesion, welding, or fasteners.

In one or more embodiments, and in view of FIG. 3, a method generally shown at 300 demonstrates one or more non-limiting ways of operating the intake manifold 140 mentioned herein elsewhere.

Referring back to method 300 and at step 310, an elastic retainer such as the elastic retainer 120 is positioned between a shaft such as the shaft 150 and a bracket such as the bracket 110. In particular, the elastic retainer 120 is positioned between the shaft 150 and the wall 132 of the bracket 110 that defines the bracket shaft aperture 130. More particularly, the elastic retainer 120 may first be received within the bracket shaft aperture 130 such as an area defined between the walls 132 and 134, and then the shaft 150 is received through the elastic retainer 120 such that the elastic retainer 120 is between the shaft 150 and the wall 132 of the bracket 110. Further in view of FIG. 10 and FIG. 2, the arm pin 192 may, along with the shaft 150, be received through the bracket shaft aperture 130. As may be mentioned herein elsewhere, the arm pin 192 may be pre-connected to the shaft 150 prior to their placement toward the bracket shaft aperture 130. Alternatively, the arm pin 192 and the shaft 150 may be placed toward the bracket shaft aperture 130 sequentially and be assembly together after the insertion.

At step 320, the elastic retainer 120 is contacted with one or more of the exterior surface 146 of an intake manifold such as the intake manifold 140, the shaft 150 and an arm pin such as the arm pin 192, and a wall of the bracket such as the wall 132. The bracket 110 moves towards the housing 145 of the intake manifold with a relatively closer contact, via optionally connecting the first and second fasteners 172, 182 at the first and second fastener portions 174, 184, respectively.

At step 330, the elastic retainer 120 may be replaced as needed due to wear and tear. This may be carried out by separating the bracket 110 away from the housing 145 of the intake manifold 140, among others. The separation in turn may be carried out via the release of the first and second fasteners 172, 182. In the event that the first and second fastener portions 184, 184 are separable from the shaft portion 190, the elastic retainer 120 may be released without necessarily having to remove the actuating arm 195.

At step 340, the elastic retainer is removed in preparation for the replacement.

At step 350, a second or new elastic retainer may be installed after the removal of the old one per step 340. The installation may be similarly carried out in view of step 310 and follow steps 320 through 340 thereafter.

The method 300 along with its suitable variations provides a relatively easy way of installing and removing an elastic retainer to ensure certain operational parameters within the context of an intake manifold such as the intake manifold 140.

In one or more embodiments, the present invention provides a bracket assembly, an intake manifold employing the bracket assembly, and a method of operating the intake manifold. However, one skilled in the art will readily recognize from such discussion, and from the accompanying drawings and claims that various changes, modifications and variations can be made therein without departing from the true spirit and fair scope of the invention as defined by the following claims.

What is claimed is:

1. A bracket assembly for an intake manifold having a shaft, comprising:
a bracket to be positioned at least partially external to the intake manifold and defining a shaft aperture to partially receive the shaft; and
an elastic retainer to be positioned at least partially between the shaft and a wall of the shaft aperture.

2. The bracket assembly of claim 1, wherein the elastic retainer is positioned to contact the shaft.

3. The bracket assembly of claim 1, wherein the elastic retainer is positioned to contact an external surface of the intake manifold.

4. The bracket assembly of claim 1, further comprising an actuating arm positioned to contact the shaft.

5. The bracket assembly of claim 4, wherein the actuating arm contacts the elastic retainer.

6. The bracket assembly of claim 4, wherein the actuating arm includes a main arm and an arm pin, the arm pin being positioned to contact the shaft, the main arm extending from the arm pin at an angle.

7. The bracket assembly of claim 4, wherein the actuating arm includes a main arm and an arm pin, the arm pin to be positioned between the intake manifold and the main arm.

8. The bracket assembly of claim 1, wherein the bracket defines first and second fastener apertures to receive first and second fasteners, respectively, the elastic retainer being positioned between the first and second fastener apertures.

9. The bracket assembly of claim 1, wherein the elastic retainer is positioned to be partially between the bracket and an external surface of the intake manifold.

10. The bracket of claim 1, further comprising an actuating arm, the elastic retainer is positioned to contact both the actuating arm and an external surface of the intake manifold.

11. An intake manifold comprising:
a housing;
a shaft supported on the housing;
a bracket positioned at least partially external to the housing and defining a shaft aperture to receive the shaft; and
an elastic retainer positioned at least partially between the shaft and a wall of the shaft aperture.

12. The intake manifold of claim 11, wherein the elastic retainer contacts an external surface of the housing.

13. The intake manifold of claim 11, wherein the elastic retainer contacts at least one of the shaft and the wall of the shaft aperture.

14. The intake manifold of claim 11, further comprising an actuating arm including an arm pin and a main arm extending from the arm pin.

15. The intake manifold of claim 14, wherein the elastic retainer contacts the arm pin.

16. A method of operating an intake manifold, the intake manifold including a housing, a shaft supported on the housing, and a bracket positioned at least partially external to the housing and defining a shaft aperture to receive a portion of the shaft, the method comprising:
providing an elastic retainer to receive there-through a portion of the shaft.

17. The method of claim 16, further comprising contacting the shaft with the elastic retainer.

18. The method of claim 16, further comprising contacting an external surface of the housing with the elastic retainer.

19. The method of claim 16, further comprising positioning the elastic retainer between the bracket and an external surface of the housing.

20. The method of claim 16, further comprising removing the elastic retainer and providing a second elastic retainer to receive there-through the shaft.
